(19) United States
(12) Patent Application Publication
(10) Pub. No.: US 2015/0149091 A1
(43) Pub. Date: May 28, 2015

(54) Apparatus and Method for Determining the Quality or Accuracy of Reported Locations

(71) Applicant: PlaceIQ, Inc., New York, NY (US)

(72) Inventors: Stephen Milton, Lyons, CO (US); Duncan McCall, Greenwhich, CT (US)

(21) Appl. No.: 14/553,422

(22) Filed: Nov. 25, 2014

Related U.S. Application Data
(60) Provisional application No. 61/908,560, filed on Nov. 25, 2013.

(51) Int. Cl. G01V 99/00; G01V 13/00

(52) U.S. Cl. CPC G01V 99/00; G01V 13/00
USPC 702/2

(57) ABSTRACT

Provided is a process of ascertaining the accuracy of geolocations in a collection of location histories, the process including: obtaining a collection of location histories describing user geolocations, each location history including: a location-history identifier distinguishing the respective location history from other location histories among the collection of location histories, and time-stamped geolocation coordinates specifying geographic locations associated with a respective mobile computing device, the collection of location histories describing geolocations of a plurality of mobile computing; analyzing the collection of location histories by, at least in part, calculating one or more quality attributes of the collection of location histories indicative of differences between the collection of location histories and other collections of location histories known to be of adequate quality; calculating one or more quality scores based on the one or more quality attributes; and storing the one or more quality scores in memory.

### CROSS-REFERENCE TO RELATED APPLICATIONS

The present application is a non-provisional of, and claims the benefit of, U.S. Patent Application 61/908,560, filed 25 Nov. 2013, and having the same title as this filing. The entire content of each above-listed parent filing is incorporated by reference in its entirety for all purposes.

### BACKGROUND

1. Field

The present invention relates generally to geolocation data and, more specifically, to techniques for determining the quality or accuracy of reported geolocations.

2. Description of the Related Art

An enormous amount of effort is expended to present the right advertisement to the right person at the right time. Consumers have limited attention, and advertisers have limited budgets. And wasting either is expensive. Yet much advertising is still wasted on ads presented to users for whom the advertisement is ineffective or not relevant.

Accordingly, advertisers are interested in techniques for targeting their advertising efforts. A particularly powerful criteria for targeting advertisements is geographic location. Often advertisers find location to convey useful information about the type of consumers that will be potentially exposed to an advertisement, and the location history of consumers is often indicative of which ads are likely to be relevant to those consumers. Consequently, advertisements are often purchased for presentation in a geographic area or targeted to specific consumers based, in part, on consumers' location histories. In one common scenario, an online publishers (e.g., entities serving content on websites, like mobile websites, or in native mobile applications) serves content to a given end user (e.g., on a smartphone, tablet, laptop, or the like), and the publisher request an advertisement to be shown with this content (either with a back-end request at the publisher's server or with a client-side request). The request generally identifies the publisher, such that the publisher can be compensated. Often this request identifies a geolocation where the advertisement is purported by the publisher to be shown (e.g., as reported back to the publisher by a native application polling a global-positioning system (GPS, or other satellite navigation system) sensor on a mobile device, based on IP address geocoding, cell-tower triangulation, low-energy Bluetooth™ beacons, or the like). In response to the request (e.g., in an auction), or in advance, an advertiser may purchase the right to supply an advertisement responsive to the request, and the price the advertiser is willing to pay may depend on the geolocation identified in the request, as advertisers often wish to target particular geographic areas, or in more sophisticated use cases, consumers with location histories indicative of certain behaviors or attributes. In some cases, this request is routed through an advertising network that acts as an intermediary between publishers and advertisers.

However, both entities selling advertising inventory and those purchasing such inventory face challenges relating to the quality and accuracy of geolocation data. Generally, one factor in the price parties are willing to pay for advertising inventory is the quality of the geolocation data indicating where the advertising inventory is targeted, e.g., the geographic locations of likely viewers of advertisements presented through smart-phones, tablets, and other mobile devices, or desktop computers, set-top boxes, televisions, electronic billboards, or other generally fixed-location devices. The locations, as mentioned above, are often indicated in a request for an advertisement to be served, and such requests may be logged for later assessment. High-quality, fine-granularity, accurate geolocation data relating to ad inventory may raise the value of that inventory. Factors affecting the quality and accuracy of geolocation records are numerous and include the number of significant digits with which latitude and longitude are reported and the mechanism by which geolocations are determined (e.g., whether the data set comes from a party that geocodes IP addresses rather than acquiring location from GPS sensors on a mobile device). In another example, some advertisers may purchase location histories of users for use in later targeting. The quality and accuracy of those location histories may affect the price an advertiser is willing to pay.

Evaluating the quality and accuracy (which is an attribute of quality) of such data is, in practice, difficult and expensive with existing techniques. Often the quantity of geolocations referenced in a data set corresponding to advertising inventory is relatively large, e.g., thousands of time-stamped geolocation coordinates for millions of users. Manually plotting geolocations and evaluating accuracy and quality with human reviewers, for example, is overly subjective (making comparison of different data sets difficult), cumbersome, slow, and very expensive to the point of not being practical with typical data sets. And those purchasing advertising inventory or re-selling advertising inventory often wish to independently evaluate the accuracy and quality of reported geolocation from a publisher, application developer, or the like based primarily on the reported geolocations (as opposed to more expensive empirical techniques, e.g., manually generating a geolocation record and then comparing that to a measured GPS signal in the field), as those purchasing and reselling such advertising inventory may receive such datasets from a relatively large number of advertising inventory sellers, some of which may intentionally or un-intentionally falsify data (e.g., adding significant digits to location coordinates, reporting the latitude and longitude of a centroid of the nearest zip code for every consumer in the zip code rather than a more accurate geolocation, etc.).

### SUMMARY

The following is a non-exhaustive listing of some aspects of the present techniques. These and other aspects are described in the following disclosure.

Some aspects include a process of ascertaining the accuracy of geolocations in a collection of location histories, the process including: obtaining a collection of location histories describing user geolocations, each location history including: a location-history identifier distinguishing the respective location history from other location histories among the collection of location histories, and time-stamped geolocation coordinates specifying geographic locations associated with a respective mobile computing device, the collection of location histories describing geolocations of a plurality of mobile computing; analyzing the collection of location histories by, at least in part, calculating one or more quality attributes of the collection of location histories indicative of differences between the collection of location histories and other collections of location histories known to be of adequate quality; calculating one or more quality scores based on the one or more quality attributes; and storing the one or more quality scores in memory.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an example of a geographic-data evaluator in accordance with some embodiments;

FIGS. 2 and 3 show examples of data visualizations produced by the geographic-data evaluator of FIG. 1;

FIG. 4 shows an example of a process of evaluating and making decisions based on the quality of a collection of location histories from a single provider of user geolocation;

FIG. 5 shows an example of a process of visually inspecting a collection of location histories to evaluate the quality of data from a single provider of user geolocations;

FIG. 6 shows an example of a process of analyzing a distribution of digits in a collection of location histories from a single provider of user geolocation;

FIG. 7 shows an example of a process of analyzing an amount of significant digits in a collection of location histories from a single provider of user geolocation;

FIG. 8 shows an example of a process of analyzing the information efficiency of marginal digits in geolocation coordinates in a collection of location histories from a single provider of user geolocation;

FIG. 9 shows an example of a process of analyzing distributions of geolocations of each user in a collection of location histories from a single provider of user geolocation; and

FIG. 10 shows an example of a computing device by which the above systems may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

The present disclosure includes techniques that, in some embodiments, extend, build upon, improve, or are complementary to the systems, devices, and methods disclosed in U.S. patent application Ser. No. 13/734,674, titled “APPARATUS AND METHOD FOR PROFILING USERS” and in U.S. patent application Ser. No. 13/938,974, titled “PROJECTING LOWER-GEOGRAPHIC-RESOLUTION DATA ONTO HIGHER-GEOGRAPHIC-RESOLUTION AREAS.” Accordingly, the disclosure of these applications is hereby incorporated by reference in its entirety for all purposes.

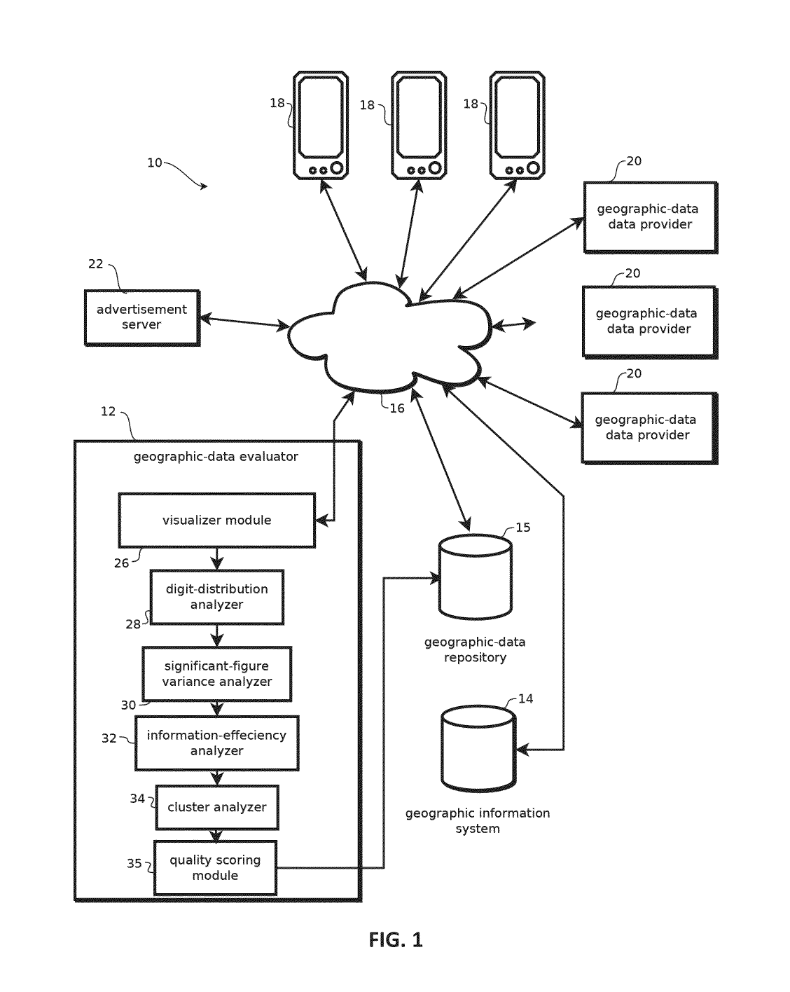

FIG. 1 illustrates a computing environment 10 having an geographic-data evaluator 12 that, in some embodiments, allows ad-companies to better price inventory based on its quality (e.g., based on the quality and accuracy of geolocations associated with the inventory), which is expected to be a clear differentiator in the market as such measures of quality are expected to provide a better understanding of the quality of the location histories and thus the accuracy of geo-location ad targeting relative to traditional systems.

Some embodiments of the geographic-data evaluator 12 may be configured to accurately estimate the reported location accuracy of a location history data set having a plurality of location records, each record specifying a latitude, longitude, a time at which the location was determined, and a device id of a device determined to be at the location. The geographic-data evaluator 12 may be operable to eliminate or mitigate several types of inaccuracies often present in such data sets, including:
a. Click fraud, such as from computer generated ad traffic, rather than organically generated traffic arising from users viewing ads throughout the day as they generate a more realistic location history;
b. Application location inaccuracy, as may arise from a particular application or new release that has degraded accuracy because of a software bug or the like;
c. Network or exchange location inaccuracy, such as a particular platform issue that might degrade accuracy; and
d. Lower accuracy location data (for instance, calculated via IP address, street geocoding or other indirect measurement techniques, rather that direct measurement of GPS signals or other aspects of a handset or other computing device's wireless environment) being presented as higher resolution (e.g., with more significant digits, or falsified less significant digits in coordinates) than the measurement warrants.

It is important to note, however, that not all of the above-mentioned problems are addressed by all embodiments, as some embodiments reflect various engineering and cost trade-offs that cause those embodiments to address only some of the above-mentioned problems or other problems with conventional systems. Moreover, it should be noted that the present techniques address problems in the field that are nascent and will likely seem more apparent in the future, as use of geolocation data is expected to become substantially more common. Accordingly, the reader should keep in mind that recognition of these problems at this time is an important aspect of providing the presently described solutions to such problems, and readers should not assume that these problems were readily apparent to those skilled in the art at the present time, regardless of how apparent such problems become in the future.

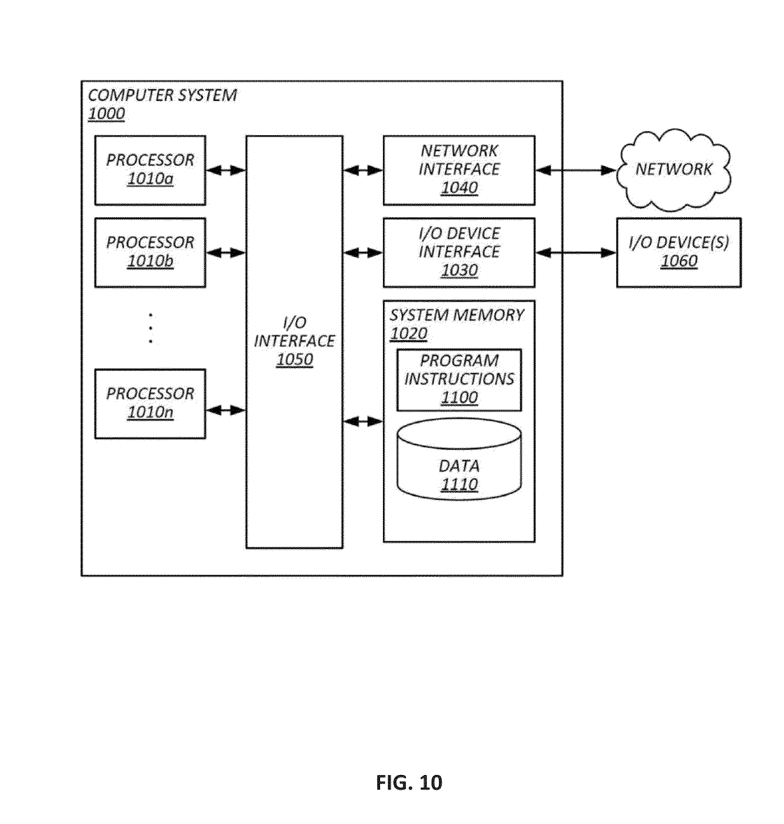

Embodiments of the geographic-data evaluator 12 may be implemented with one or more of the computing devices described below with reference to FIG. 10, e.g., by processors executing instructions stored in the below-described memory for providing the functionality described herein. FIG. 1 shows a functional block diagram of an example of the geographic-data evaluator 12. While the functionality is shown organized in discrete functional blocks for purposes of explaining the software and hardware by which the geographic-data evaluator 12 may be implemented in some embodiments, is important to note that such hardware and software may be intermingled, conjoined, subdivided, replicated, or otherwise differently arranged relative to the illustrated functional blocks. Due to the size of some geographic data sets (which may be as large as 100 billion ad requests, or larger, in some use cases), some embodiments may include a plurality of instances of the geographic-data evaluator 12 operating concurrently to evaluate data in parallel, and some embodiments may include multiple instances of computing devices instantiating multiple instances of some or all of the components of the geographic-data evaluator 12, depending on cost and time constraints. In some cases, the geographic data sets document earlier reported geolocations and, thus, contain a collection of location histories from a given provider of user geolocations.

The geographic-data evaluator 12 may be understood in view of the exemplary computing environment 10 in which it operates. As shown in FIG. 1, the computing environment 10 further includes a geographic information system 14, a geographic-data repository 15, the Internet 16, user devices 18, geographic data providers 20 (e.g., mobile website publishers, retargeting services, and providers of mobile device applications, or native apps), and an advertisement server 22. The components of the computing environment 10 may connect to one another through the Internet 16 and, in some cases, via various other networks, such as cellular networks, local area networks, wireless area networks, personal area networks, and the like.

The geographic information system 14 may be configured to provide information about geographic locations in response to queries specifying a location of interest. In some embodiments, the geographic information system 14 organizes information about a geographic area by quantizing (or otherwise dividing) the geographic area into area units, called tiles, that are mapped to subsets of the geographic area. In some cases, the tiles correspond to square units of area having sides that are between 10-meters and 1000-meters, for example, approximately 100-meters per side, depending upon the desired granularity with which a geographic area is to be described. Tiles are, however, not limited to square-shaped tiles, and may include other tilings, such as a hexagonal tiling, a triangular tiling, or other regular tilings (for simpler processing), semi-regular tilings, or irregular tilings (for describing higher density areas with higher resolution tiles, while conserving memory with larger tiles representing less dense areas).

In some cases, the attributes of a geographic area change over time. Accordingly, some embodiments divide each tile according to time. For instance, some embodiments divide each tile into subsets of some duration of time, such as one week, one month, or one year, and attributes of the tile are recorded for subsets of that period of time. For example, the period of time may be one week, and each tile may be divided by portions of the week selected in view of the way users generally organize their week, accounting, for instance, for differences between work days and weekends, work hours, after work hours, mealtimes, typical sleep hours, and the like. Examples of such time divisions may include a duration for a tile corresponding to Monday morning from 6 AM to 8 AM, during which users often eat breakfast and commute to work, 8 AM till 11 AM, during which users often are at work, 11 AM till 1 PM, during which users are often eating lunch, 1 PM till 5 PM, during which users are often engaged in work, 5 PM till 6 PM, during which users are often commuting home, and the like. Similar durations may be selected for weekend days, for example 8 PM till midnight on Saturdays, during which users are often engaged in leisure activities. Each of these durations may be profiled at each tile.

In some embodiments, the geographic information system 14 includes a plurality of tile records, each tile record corresponding to a different subset of a geographic area. Each tile record may include an identifier, an indication of geographic area corresponding to the tile (which for regularly sized tiles may be the identifier from which location can be calculated or may be a polygon with latitude and longitude vertices, for instance), and a plurality of tile-time records. Each tile-time record may correspond to one of the above-mentioned divisions of time for a given tile, and the tile-time records may characterize attributes of the tile at different points of time, such as during different times of the week. Each tile-time record may also include a density score indicative of the number of people in the tile at a given time. In some embodiments, each tile-time record includes an indication of the duration of time described by the record (e.g. lunch time on Sundays, or dinnertime on Wednesdays) and a plurality of attribute records, each attribute record describing an attribute of the tile at the corresponding window of time during some cycle (e.g., weekly).

The attributes may be descriptions of activities in which users engage that are potentially of interest to advertisers or others interested in geographic data about human activities and attributes (e.g., geodemographic data or geopsychographic data). For example, some advertisers may be interested in when and where users go to particular types of restaurants, when and where users play golf, when and where users watch sports, when and where users fish, or when and where users work in particular categories of jobs. In some embodiments, each tile-time record may include a relatively large number of attribute records, for example more than 10, more than 100, more than 1000, or approximately 4000 attribute records, depending upon the desired specificity with which the tiles are to be described. Each attribute record may include an indicator of the attribute being characterized and an attribute score indicating the degree to which users tend to engage in activities corresponding to the attribute in the corresponding tile at the corresponding duration of time. In some cases, the attribute score (or tile-time record) is characterized by a density score indicating the number of users expected to engage in the corresponding activity in the tile at the time.

Thus, to use some embodiments of the geographic information system 14, a query may be submitted to determine what sort of activities users engage in at a particular block in downtown New York during Friday evenings, and the geographic information system 14 may respond with the attribute records corresponding to that block at that time. Those attribute records may indicate a relatively high attribute score for high-end dining, indicating that users typically go to restaurants in this category at that time in this place, and a relatively low attribute score for playing golf, for example. Attribute scores may be normalized, for example a value from 0 to 10, with a value indicating the propensity of users to exhibit behavior described by that attribute.

The geographic-data repository 15, in some embodiments, stores geographic data from the geographic-data providers 20 and associated quality profiles of the geographic data, including measures of geographic data quality and accuracy provided by the geographic-data evaluator 12. In some embodiments, advertisers, publishers, or others interested in the quality of geographic data from a given data provider 20 may query the geographic-data repository 15 for information output by the geographic-data evaluator 12.

In FIG. 1, three user devices 18 are illustrated, but it should be understood that embodiments are consistent with (and most use cases entail) substantially more user devices, e.g., more than 100,000 or more than one million user devices. The illustrated user devices 18 may be mobile handheld user devices, such as smart phones, tablets, or the like, having a portable power supply (e.g., a battery) and a wireless connection, for example, a cellular or a wireless area network interface. Examples of computing devices that, in some cases, are mobile devices are described below with reference to FIG. 10. User devices 18, however, are not limited to handheld mobile devices, and may include desktop computers, laptops, vehicle in-dash computing systems, living room set-top boxes, and public kiosks having computer interfaces. In some cases, the user devices 18 number in the millions or hundreds of millions and are geographically distributed, for example, over an entire country or the planet.

Each user devices 18 may include a processor and memory storing an operating system and various special-purpose applications, such as a browser by which webpages and advertisements are presented, or special-purpose native applications, such as weather applications, games, social-networking applications, shopping applications, and the like. In some cases, the user devices 18 include a location sensor, such as a global positioning system (GPS) sensor (or GLONASS, Galileo, or Compass sensor) or other components by which geographic location is obtained, for instance, based on the current wireless environment of the mobile device, like SSIDs of nearby wireless base stations, or identifiers of cellular towers in range. In some cases, the geographic locations sensed by the user devices 18 may be reported to the advertisement server 22 for selecting advertisements to be shown on the mobile devices 18, and in some cases, location histories (e.g., a sequence of timestamps and geographic location coordinates) are acquired by the geographic-data providers 20. In other cases, geographic locations are inferred by, for instance, an IP address through which a given device 18 communicates via the Internet 16, which may be a less accurate measure than GPS-determined locations. Or in some cases, geographic location is determined based on a cell tower to which a device 18 is wirelessly connected. Depending on how the geographic data is acquired an subsequently processed, that data may have better or less reliable quality and accuracy.

In some use cases, the number of people in a particular geographic area at a particular time as indicated by such location histories may be used to update records in the geographic information system 14, which may be used by an advertiser when determining how much to bid on an advertisement. Location histories may be acquired by batch, e.g., from application program interfaces (APIs) of third-party providers, like cellular-network operators, advertising networks, or providers of mobile applications. Batch formatted location histories are often more readily available than real-time locations, while still being adequate for characterizing longer term trends in geographic data. And some embodiments may acquire locations in real time, for instance, for selecting a particular advertisement to be displayed based on the current location.

FIG. 1 shows three geographic data providers 20, but again, embodiments are consistent with substantially more instances, for example, numbering in the hundreds of thousands. The geographic data providers 20 are shown as network connected devices, for example, servers hosting APIs by which geographic data is requested by the geographic-data projector 12, or in webpages from which such data is retrieved or otherwise extracted. It should be noted, however, that in some cases the geographic data may be provided by other modes of transport. For instance, hard-disk drives, optical media, flash drives, or other memory may be shipped by physical mail and copied to a local area network or on-board memory accessible to the geographic-data projector 12. In some cases, the geographic data is acquired in real time or in batches, for example periodically, such as daily, weekly, monthly, or yearly, but embodiments are consistent with continuous data feeds as well.

Generally, the entity operating the geographic-data evaluator 12 does not have control over the quality or accuracy of the provided geographic data, as that data is often provided by a third-party, for instance, sellers of geocoded advertising inventory, the data being provided in the form of ad request logs from various publishers. In some cases, the geographic data comprehensively canvasses a larger geographic area, for example, every zip code, county, province, or state within a country, or the geographic data may be specific to a particular area, for example, within a single province or state for data gathered by local government or local businesses. Publishers acting as the provider of the geographic data may be an entity with geocoded advertising inventory to sell, e.g., ad impressions up for auction that are associated with a geographic location at which the entity represents the add will be presented. As noted above, pricing for such advertising inventory is a function, in part, of the quality and accuracy of the associated geographic locations.

The illustrated advertisement server 22 is operative to receive a request for advertising content, select content (e.g. images and text), and send the advertisement for display or other presentation to a user. One advertisement server 22 is shown, but embodiments are consistent with substantially more, for example, numbering in the thousands. In some cases, advertisements are selected or bid upon with a price selected based on the geographic location of a computing device upon which an advertisement will be shown, which may be indicated by one of the geographic-data providers, entities may also be a publisher selling the advertising inventory. Accordingly, the accuracy and quality of such geographic data may be of relevance to the parties selling or buying such advertising space. The selection or pricing of advertisements may also depend on other factors. For example, advertisers may specify a certain bid amount based on the attributes of the geographic area documented in the geographic information system 14, or the advertiser may apply various thresholds, requiring certain attributes before an advertisement served, to target advertisements appropriately.

In some embodiments, the geographic-data evaluator 12 is configured to analyze the location quality of combinations of location history data (e.g., from the geographic-data data providers 20), such as ad request logs indicating, for instance, a plurality of requests for advertisements from publishers (e.g., operators of various websites or mobile device native applications), each request being for an advertisements to be served at a geolocation specified in the request. The geographic location specified in a given request may be used by an advertiser to determine whether to bid on or purchase the right to supply the requested advertisement, and the amount an advertiser wishes to pay may depend on the accuracy and quality of the identified geolocation. This location history records may contain a plurality of such requests, each having a geolocation (e.g., a latitude coordinate and a longitude coordinate specifying where a requested ad will be served), a unique identifier such as a mobile device ID (e.g., a device identifier of a end user device 18 upon which the ad will be shown) and a timestamp.

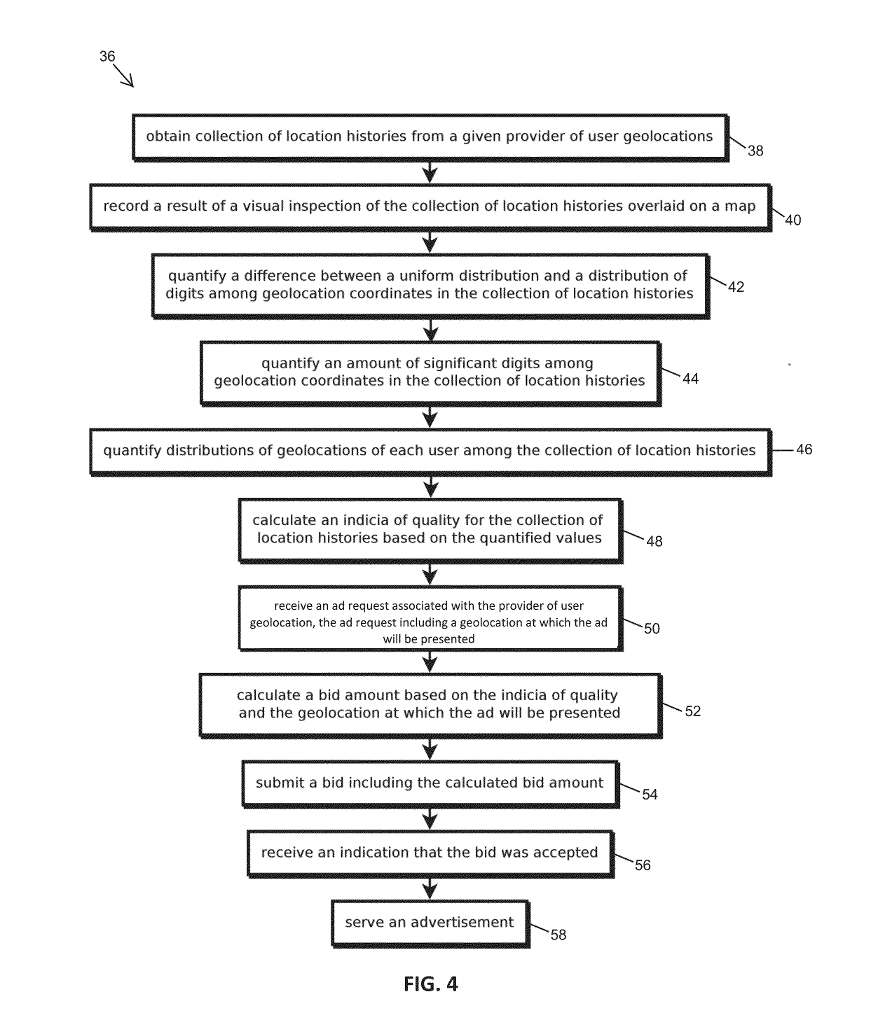

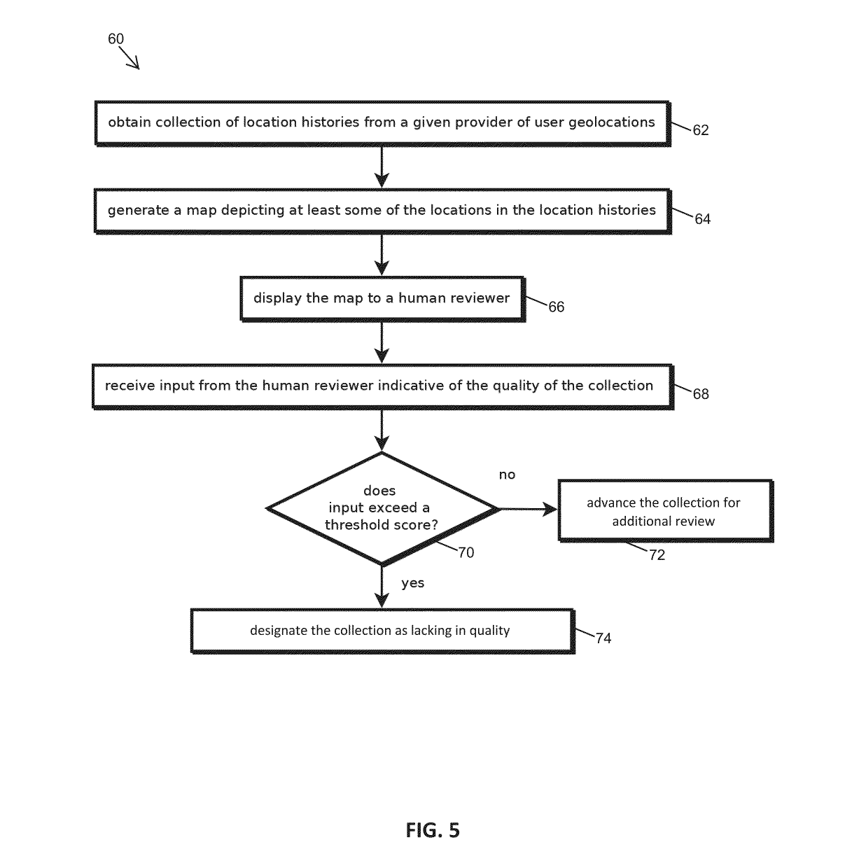

In some cases, the geographic-data evaluator 12 may perform the process of FIG. 4 36, steps of which are explained by way of example with reference to FIGS. 5-8. In some cases, the process of FIG. 4 36 includes the following steps: obtain collection of location histories from a given provider of user geolocations 38; record a result of a visual inspection of the collection of location histories overlaid on a map 40; quantify a difference between a uniform distribution and a distribution of digits among geolocation coordinates in the collection of location histories 42; quantify an amount of significant digits among geolocation coordinates in the collection of location histories 44; quantify distributions of geolocations of each user among the collection of location histories 46; calculate an indicia of quality for the collection of location histories based on the quantified values 48; receive an ad request associated with the provider of user geolocation, the ad request including a geolocation at which the ad will be presented 50; calculate a bid amount based on the indicia of quality and the geolocation at which the ad will be presented 52; submit a bid including the calculated bid amount 54; receive an indication that the bid was accepted 56; and serve an advertisement 58. In some cases, process of FIG. 4, like the other processes described herein, may be performed in a different order, or subsets of the process of FIG. 4 may be performed, as the various analyses described are independently useful, which is not to suggest that any other feature may not be omitted in some embodiments.

The geographic-data evaluator 12 may include a visualization module 26, digit-distribution analyzer 28, significant-figure variance analyzer 30, information-efficiency analyzer 32, cluster analyzer 34, and quality scoring module 35, each of which individually or collectively may be instantiated in one of the below-describes computer systems described with reference to FIG. 10. In some cases, the geographic-data evaluator 12 uses a number of measurements that are ultimately combined into to two metrics or quality scores: hyper-locality and clusterability. These measurements may involve advanced data science techniques such as the information efficiency of the location information moving from lower resolutions to higher resolutions, the average number of clusters (as it is expected that most users should cluster around a few points in space and time), the compactness of the clusters, the number of significant digits in the latitudes and longitudes, and whether the data has “sinkholes” or high concentrations of repeated spatial coordinates such as the zip or metro centroids that plague ad request logs. Such sinkholes are usually a sign that the generator of the location data 20 is sending an IP to latitude/longitude mapping (which is generally of lower quality and accuracy) instead of the true GPS latitude-longitude (which is generally of higher quality and accuracy).

As noted above, in the context of mobile advertising, embodiments of the geographic-data evaluator 12 may allow ad-companies to better price inventory based on its quality, and is a clear differentiator in the market as it provides a better understanding of the quality of the location histories and thus the accuracy of geo-location ad targeting.

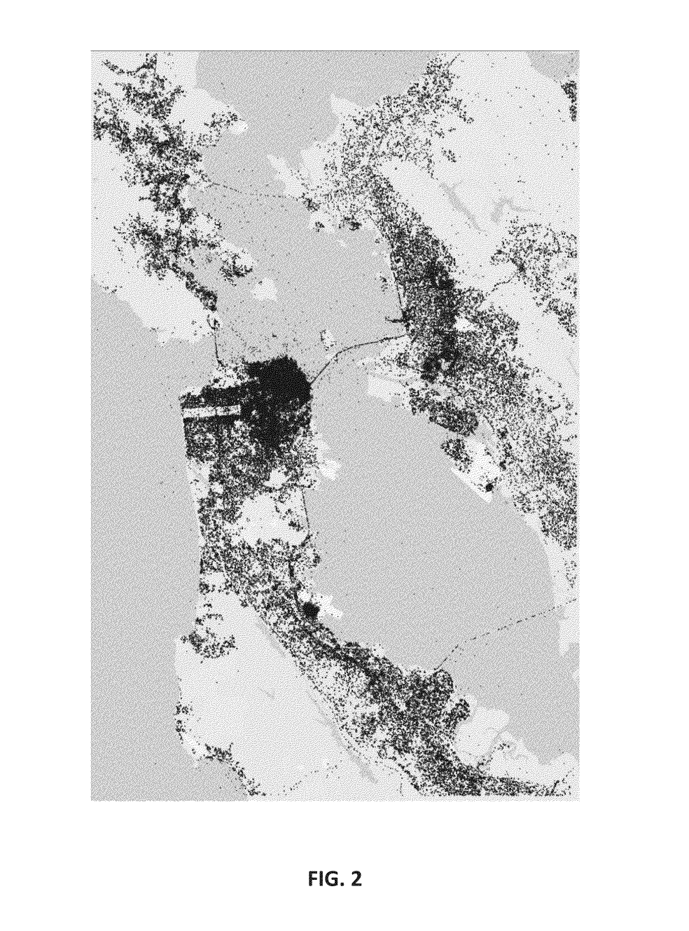

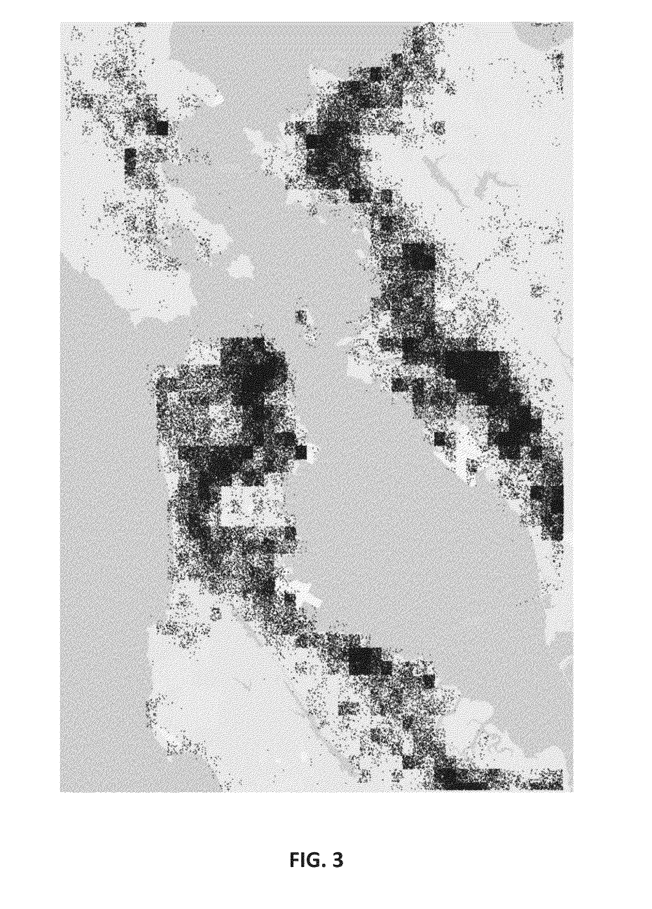

In some embodiments, a set of geographic data, such as one of the above-mentioned ad-request logs, may be acquired from one of the geographic-data data providers 20 by the visualizer module 26, which may construct visualizations for presentation to a human operator to evaluate location quality based on the visualization. To this end, some embodiments of the visualizer module 26 may, for example, pull a sample of location histories for the San Francisco metro area and plot them in MapBox or TileMill, or other mapping visualization tools. Examples of such resulting visualizations are illustrated in FIGS. 2 and 3, which map latitude and longitude to pixel locations overlaid on a corresponding map extent. As indicated by differences between these figures (FIG. 3 showing evidence of lower-quality quantized geolocations appearing as a blocky dispersion) that will be apparent to the reader, generating such visualizations often allow the viewer to immediately judge some location history data to be of poor quality and discontinue the evaluation. In some cases, the visualization is presented in a user interface with an input for the viewer to select whether the visualization appears to show data of high enough quality that further analysis is wanted. The user input may be received by the geographic data evaluator 12, stored, and used to determine whether to proceed with additional steps. In some cases, the input is a score (e.g., a binary score, or a rating from 1 to 10 by the human review). In some cases, the multiple scores are entered by a human reviewer to evaluate the data along multiple dimensions (e.g., comprehensiveness, representativeness, plausibility of distribution relative to distributions seen with known high-quality data sets, etc.). The scores may be stored in memory of the evaluator 12 in association with the data set for use in calculating an aggregate quality metric based on, for instance, a weighted combination with values obtained through subsequent steps. If the human reviewer determines that further analysis is not warranted, the process may stop and another data set may be acquired, or if the human reviewer determines that further analysis is warranted, the acquired data set may be advanced to other components of the geographic-data evaluator 12.

In some cases, the visual analysis may be performed algorithmically. For instance, the data set may be scored with a Haar wavelet transform, or other edge detection algorithm, and an amount of detected edges (e.g., a density of edges relative to an aggregate density over a geographic area) may be compared to an algorithm to detect an excess of artificial edges arising from manipulation of less significant digits. In some cases, edges may be culled prior to such a comparison based on directionality of the edge, to remove or suppress edges associated with, e.g., a road traveling North-West, relative to an edge running precisely North-to-South, or East-to-West, as may occur when digits of reported longitude and longitude are manipulated. In another example, a Fourier analysis of point density as a function of latitude or longitude may be performed, and embodiments may normalize and threshold the resulting frequency domain data to detect peaks in frequency associated with patterns arising from digit manipulation (e.g., detecting an unnatural peak corresponding to the unit squares of the “blocky” pattern exhibited by FIG. 3. Such measurements and determinations may be made based on collections of location histories corresponding to a large number of users, in contrast to other determinations made on a user-by-user (or location-history by location-history) bases, as described below, which is not to suggest that visual inspection (or the algorithmic equivalent) cannot also be performed one location-history at a time.

In some cases, the visualization module 26 may perform the process of FIG. 5 60, steps of which are explained above by way of example. In some cases, the process includes the following steps: obtain collection of location histories from a given provider of user geolocations 62; generate a map depicting at least some of the locations in the location histories 64; display the map to a human reviewer 66; receive input from the human reviewer indicative of the quality of the collection 68; determining whether the input exceeds a threshold score 70; upon such a determination, advance the collection for additional review 72; otherwise, designate the collection as lacking in quality 74.

In some embodiments, data sets that pass the visualization test may be advanced to the digit-distribution analyzer 28, which may be configured to calculate metrics based on the distribution of digits in the geographic coordinates. These distributions are distinct from the distribution of values expressed by those digits in the context of numbers, e.g., the digit 1 is relatively common among the distribution of digits in the following numbers, while none of the numbers themselves, or their average, is equal to, or approximate to, the number one.: 2.121719112; 51.411514; 1934.1811193; 0.0012116171; and 5141611.71131.

In some cases, the calculated digit-distribution metrics may reflect the distribution of the individual digits after the decimal places. In some cases, only digits after some threshold number of positions after the decimal place are analyzed, e.g., if the threshold is 2, then the digits 6, 3, 8, 9, 5, 3, and 7 in the number 57.136389537 would be included for that number when assessing digit distributions. In some embodiments, this threshold is selected based on the size of the area spanned by the location histories, e.g., the length and width of a bounding box containing the location histories in a collection, where larger lengths (East to West) correspond to smaller threshold positions (closer to the decimal point) for latitude digits, and larger heights (North to South) correspond to smaller thresholds for longitude digits. Adjusting the threshold based on the geographic area spanned by a collection of location histories may prevent truly-representative, more-significant digits from skewing the analysis. In other cases, a fixed number of digits is used as the threshold.

In some cases, the distribution of digits in all numbers is analyzed as well as the joint distribution, e.g. for the coordinate pair (90.123456, 88.981239), the first digit for the latitude will be 1 and for the longitude will be 9 while the joint pair will be (1,9) and for the second digits the coordinate pair is (2,8), respectively. Some embodiments may also account for height, and some analyses may further analyze digits in triplets in a similar fashion (e.g., one digit from the latitude, one from the longitude, and one for altitude, time, speed, etc.). Location may be expressed in a variety of formats other than latitude and longitude, including in relative position coordinates and polar coordinates.

To analyze the distribution of digits, some embodiments may compute the Kullback-Leibler divergence (KLD) (e.g., a non-symmetric measure of the difference between two probability distributions) between these distributions with the uniform distribution, i.e., a distribution in which each digit occurs with approximately the same frequency as every other digit, or each digit pair (or triplet) occurs with the same frequency as every other pair (or triplet).

In some embodiments, each number indicating geolocation in the location histories may be converted to a string data type. Some embodiments may iterate through each character of the string. And some embodiments may maintain counters, such as one for each digit 0-9, incrementing the respective counter when a corresponding character is reached in the string, e.g., when a character position counter (reset to 0 at each new string, and incremented through positions in the string) reaches the number 4 for the string “88.362891123,” the counter for the digit “6” may be incremented. Embodiments may also maintain an overall count of each digit encountered, e.g., the string “88.362891123” may add 11 to this count. Or in some embodiments, only digits more than a threshold number of positions after the decimal point are counted in each count. In some cases, the count for each digit 0-9 may be divided by the overall count, and the difference of the result from 0.1 for each digit may be calculated to determine how much more or less frequently that digit occurs than in a uniform distribution. Some embodiments may combine these differences to calculate an aggregate measure of the difference from the uniform distribution. In some cases, because the number of location coordinate pairs in location histories is relatively large, some embodiments may sample a portion of the location histories for this analysis, or some embodiments may parallelize operations, e.g., with a MapReduce implementation in which a digit detecting function is mapped to a plurality of computing nodes, and counts for each digit are reduced out from another plurality of computing nodes. In some cases, the overall count is calculated by summing the counts for each digit. Thus, such analyses may indicate whether some digits in the location histories occur more often than others.

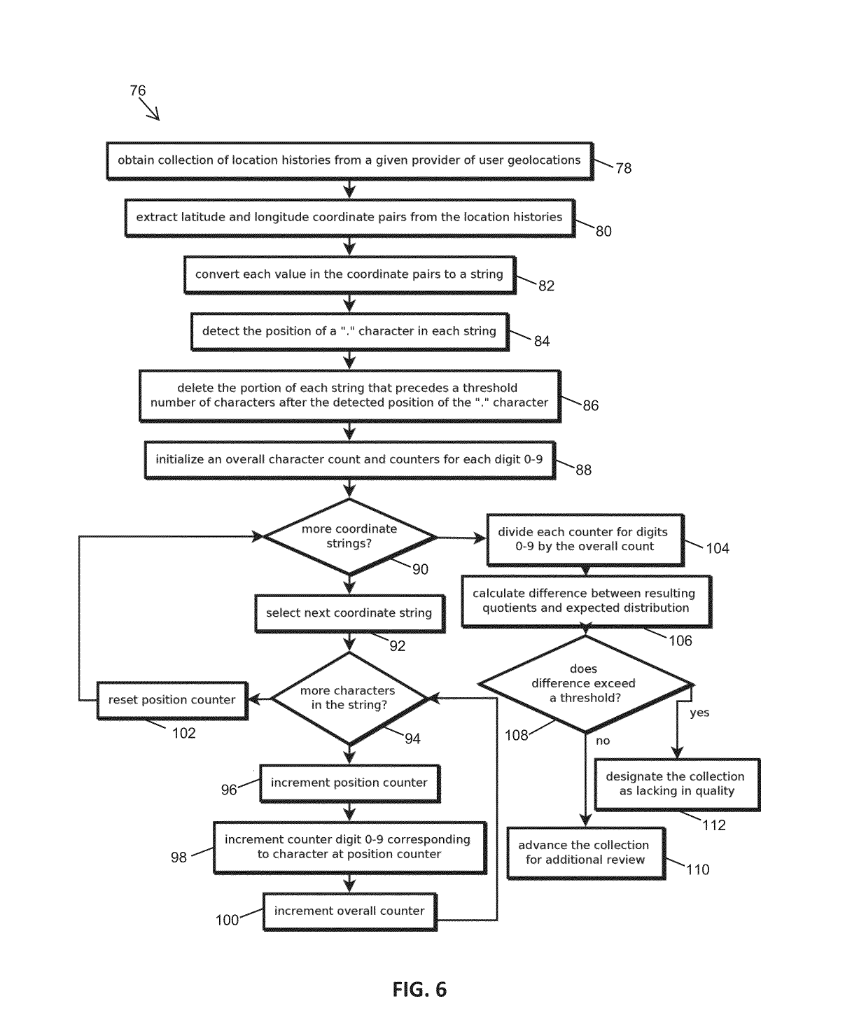

In some cases, the digit-distribution analyzer 28 may perform the process of FIG. 6 76, steps of which are explained above by way of example. In some cases, the process includes the following steps: obtain a collection of location histories from a given provider of user geolocations 78; extract latitude and longitude coordinate pairs from the location histories 80; convert each value in the coordinate pairs to a string 82; detect the position of a “.” character in each string 84; delete the portion of each string that precedes a threshold number of characters after the detected position of the “.” character 86; initialize an overall character count and counters for each digit 0-9 88; determine whether there are more strings 90; upon such a determination, select next coordinate string 92; determine whether there are more characters in the string 94; upon such a determination, increment position counter 96, increment counter for digit 0-9 corresponding to character at position counter 98, and increment an overall counter 100; otherwise reset a position counter 102; upon determining that no more strings remain, divide each counter for digits 0-9 by the overall count 104; calculate a difference between resulting quotients and expected distribution 106; determine whether the difference exceeds a threshold 108; upon such a determination, advance the collection for additional review 110; otherwise, designate the collection as lacking in quality 112.

Truly hyper-local coordinates of high quality and accuracy (e.g., those that are not generated from by a simple programmatic process) should have a vanishing KLD. In some cases, high-quality and accurate sets of geographic location coordinates may have a uniform distribution, and lower quality and accuracy techniques for determining geographic location may tend to deviate from a normal distribution. The presences of location coordinate sinks, for instance, tends to increase the KLD while a uniform spread of coordinates tends to decrease the KLD. These results may be stored in memory by the analyzer 28. In some cases, this score may be stored in memory for use in subsequent calculations or for display in a report on the data provider.

In some embodiments, the set of geographic data may also be advanced to the significant-figure variance analyzer 30. The variance in the number of significant figures is expected to be another telling indicator of hyper-local quality (e.g., the accuracy and quality of the geographic data). Thus, some embodiments of analyzer 30 may calculate a measure of location-history quality based on the number of significant digits with which geolocation coordinates in the location histories are reported. Consider the distribution of the maximum number of digits after the decimal point for a set of coordinates and denote this as max(sig). For the coordinate pair (90.12, 88.981239), the latitude has two-digits after the decimal point while the longitude has six-digits after the decimal point. This pair has max(sig)=6. The significant-figure variance analyzer 30 may denote (e.g., store in a variable in memory) the average of max(sig) over multiple (e.g., all, or a sampling of) coordinate pairs as ASF, and the significant-figure variance analyzer 30 may further define (e.g., calculate and store in another variable) the NASF to be the ASF normalized to lie between 0 and 1. In other embodiments, the ASF is calculated as some other measure of central tendency of max(sig), such as the median or mode. In some embodiments, if the ASF exceeds a predetermined benchmark threshold, usually taken to be 5, the NASF is mapped to 1, as determined by the significant-figure variance analyzer 30. Values less than one may represent (and be calculated by the analyzer 30 as) linearly interpolated values between 0 and the benchmark threshold, as determined by the significant-figure variance analyzer 30.

This quantity determined by the significant-figure variance analyzer 30 is a very rough measure of hyper-locality, which is included below in the hyper-locality quality score. In some embodiments, values above the benchmark do not contribute, while values less than the benchmark are penalized, as determined by the significant-figure variance analyzer 30. In some embodiments, the benchmark is chosen to be 5 to coincide with a resolution of 1.1-meter. Thus, coordinates reported with a resolution of greater than 1.1-meter may cause an aggregate indication of location quality to indicate a lower-quality set of location histories. In some cases, because the number of location coordinate pairs in location histories is relatively large, some embodiments may sample a portion of the location histories for this analysis, or some embodiments may parallelize operations, e.g., with a MapReduce implementation in which a significant-figure counting function is mapped to a plurality of computing nodes, and the maximum number of significant figures for each coordinate pair are reduced out from another plurality of computing nodes. These results may be stored in memory by the analyzer 30. In some cases, a measure of central tendency for the NASF may be calculated, and this score may be stored in memory for use in subsequent calculations or for display in a report on the data provider.

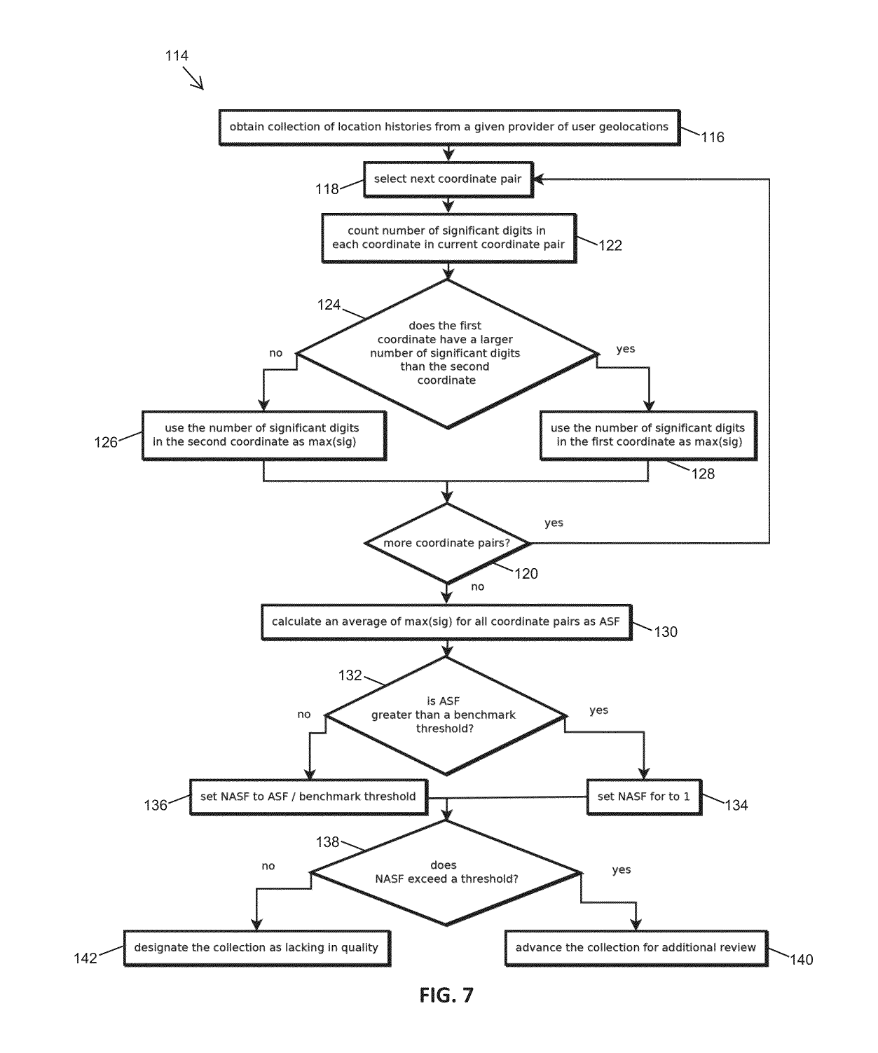

In some cases, the significant-figure variance analyzer 30 may perform the process of FIG. 7 114, steps of which are explained above by way of example. In some cases, the process includes the following steps: obtain a collection of location histories from a given provider of user geolocations 116; determine whether the collection includes more coordinate pairs 118; upon such a determination, select a next coordinate pair 120, count number of significant digits in each coordinate in current coordinate pair 122, determine whether the first coordinate has a larger number of significant digits than the second coordinate 124, upon such a determination, use the number of significant digits in the first coordinate as max(sig) 126, otherwise use the number of significant digits in the second coordinate as max(sig) 128; upon determining that all coordinate pairs have been evaluated, calculate an average of max(sig) for all coordinate pairs as ASF 130; determine whether ASF is greater than a benchmark threshold 132; upon such a determination, set NASF for to 1 134; otherwise, set NASF to ASF/benchmark threshold 136; determine whether NASF exceeds a threshold 138; upon such a determination, advance the collection for additional review 140; otherwise, designate the collection as lacking in quality 142.

In some cases, information theoretic techniques can be relatively powerful and, in some embodiments, employ computation-friendly techniques, like counting. These techniques may be implemented in the information-efficiency analyzer 32, which may also receive the geographic data set. The applicants expect that such measures will provide relatively high precision metrics for hyper-locality. Some embodiments apply the notion of information efficiency and changes in this quantity as an analysis performed by the information-efficiency analyzer 32 progresses down the zoom-stack from 1 km to 100 m to 10 m. The metric, in some embodiments, measures how much information is gained as the progression through the zoom stack add additional digits to the coordinates, e.g., given the first X digits, with what certainty can the X+1 digit be predicted—higher certainty being indicative of lower information gain. The information-efficiency analyzer 32 also may measure whether the cost of using an extra digit is the worth the information gain. This is a way to measure hyper-locality based on the amount of randomness gained with the addition of each digit. As an example, location histories that are derived by adding extra digits to an imprecise coordinate pair are expected to be uncovered by this metric.

In one example, the information-efficiency analyzer 32 determines the Efficiency-N as follows:
a. For each coordinate pair, only include the first N-digits after decimal point to form a truncated set of geolocation coordinates, X_N. Let A_N be the alphabet, or the possible coordinate pair possible with N digits after a decimal point, and X_N be the random variable the dataset is samples of over A_N.
b. Using this data set, the information-efficiency analyzer 32 may estimate a distribution for X_N. After this, the information-efficiency analyzer 32 may calculate H(X_N), which is the entropy of the data set when encoded by X_N. Mathematically, this can be expressed as H(X_N)=E(−log(P(X_N))), where E is the expected value operator, P is the probability mass function, and the logarithm is base 2 to yield bits (or other log bases may be used for other units).
c. Next, the maximum possible value H(X_N) can take, which will be when X_N is uniformly distributed over A_N, is determined by the information-efficiency analyzer 32 by calculating 2̂|A_N|. Subsequent operations are explained by denoting this upper bound of information as SUP(H(X_N)).
d. The information-efficiency analyzer 32 may then determine N digit efficiency to be EFF(X_N)=2̂(H(X_N)−SUP(H(X_N))).
e. As a result, the information-efficiency analyzer 32 may determine the N-level hyperlocality efficiency gain as: HEG_N=(EFF(X_N)−EFF(X_N−1))/EFF(X_N−1), where N−1 reflects the loss of one digit.

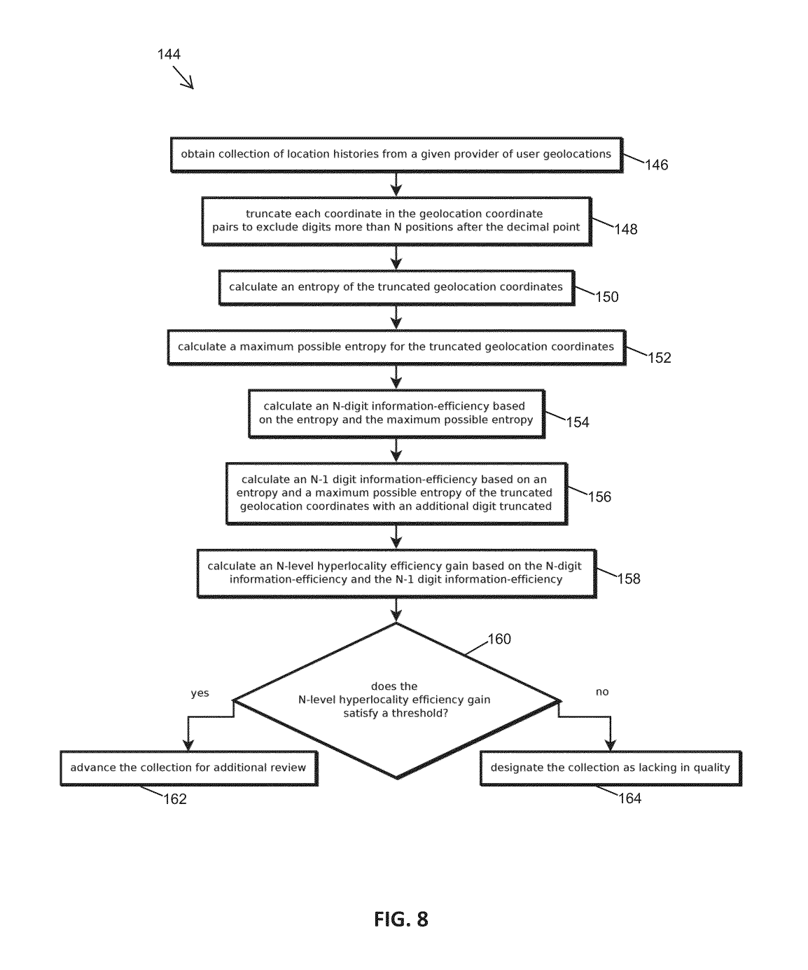

In some cases, the information-efficiency analyzer 32 may perform the process of FIG. 8 144, steps of which are explained above by way of example. In some cases, the process includes the following steps: obtain a collection of location histories from a given provider of user geolocations 146; truncate each coordinate in the geolocation coordinate pairs to exclude digits more than N positions after the decimal point 148; calculate an entropy of the truncated geolocation coordinates 150; calculate a maximum possible entropy for the truncated geolocation coordinates 152; calculate an N-digit information-efficiency based on the entropy and the maximum possible entropy 154; calculate an N−1 digit information-efficiency based on an entropy and a maximum possible entropy of the truncated geolocation coordinates with an additional digit truncated 156; calculate an N-level hyperlocality efficiency gain based on the N-digit information-efficiency and the N−1 digit information-efficiency 158; determine whether the N-level hyperlocality efficiency gain satisfies a threshold 160; upon such a determination, advance the collection for additional review 162; otherwise, designate the collection as lacking in quality 164.

In some embodiments, the cluster analyzer 34 may also receive the geographic data set. The clustering of coordinate points is expected to capture and distinguish real-life human behavior and habits from artifacts from low-quality and low-accuracy means of determining or reporting geolocations. Most people are expected to have a couple of relatively tight clusters (e.g., geographic clusters of geolocations listed in their respective location histories) that represent where they live and work. Additionally, many people also have less dense clusters around their usual social venues. This step of the presently described pipeline (though embodiments are not limited to pipelines, as some steps may be performed concurrently) measures the how clusterable a set of location histories tends to be for each of the unique identifiers (each of which may map to, and be indicative of, a different consumer/user). In some use cases, attributes of clusters (as opposed to just the individual clusters themselves) may be indicative of the verisimilitude of geolocation data. For instance, a histogram of the number clusters of geolocation data of each device ID may have a peak around two to four clusters, corresponding to work, home, and one or two frequented locations, for typical, non-falsified geolocation data. Deviations from this distribution may be indicative of low-quality geolocation data, provided that a clustering algorithm is properly tuned with correct parameters. In some cases, parameters of a clustering algorithm may be tuned with known-good geolocation data sets until the parameters yield an average (or other measure of central tendency) number of clusters for each user in the range of two-to-four. The cluster analyzer 34 may examine the distribution of the number of clusters for each identifier and the geometric qualities of the clusters. Based on this information the cluster analyzer 34 may infer both how amenable a set of location histories (e.g., an acquired geographic data set) is to clustering algorithms and how well it captures human behavior.

To this end, in some embodiments, for each unique identifier, the cluster analyzer 34 may perform DB-SCAN Clustering based on multiple (e.g., all, or a sampling of) the geolocation coordinate pairs of the respective user identifier. In some cases, the DB-SCAN parameters ε (a threshold distance) and the minimum number of points required to form a dense region (minimum_points) may be tuned based on known-good data to yield two-to-four clusters (e.g., for the average user, or for some threshold amount of user's, like 80%) for the users in the know-good geographic data set, for instance, with a stochastic gradient descent routine, or by iterating through likely ranges for each parameter until an acceptable combination is found. In some cases, minimum_points is selected based on (e.g., by multiplying an empirically determined value by) the ratio of the density of geolocations in known-good data to density of geolocations in data to be clustered to reduce the likelihood that a sparse training set will cause over-clustering in a less-sparse geolocation data set. After clustering, the cluster analyzer 34 may then calculate the following for each unique identifier (e.g., user identifier):
a. The number of geolocation clusters of the respective user in that user's location history. This number (or other amount) is referred to as D below.
b. C/T where C is the number of core trace points the user associated with the identifier has been to (as indicated by geolocations in the respective user's location history) and T is the total number of the user's trace points (e.g., geolocations in the respective user's location history). Core trace points, in some cases, are points in a location history that are determined, by the analyzer 34, to satisfy two criteria: 1) the geolocation is part of a cluster in the user's location history and 2) the geolocation has more than minimum_points within threshold distance ε. (Clusters may also include geolocations that are not core-trace points, but are within distance ε of that geolocation.) A higher value of C/T tends to indicate a more-robustly clustered geolocation history (with few border points that are more marginally connected to a cluster) and vice versa. This ratio is referred to as R below
c. The silhouette score, which is described below and referred to as S

Other embodiments may use other algorithms, such as k-means or ordering points to identify the clustering structure (OPTICS), for clustering geolocations. Various criteria to consider when selecting among options for clustering algorithms include whether the algorithm is deterministic, how the algorithm scales in memory space with more data, and how the algorithm scales in computational complexity with more data.

To calculate the silhouette score, first the cluster analyzer 34 may calculate the mean (or other measure of central tendency) for each of the above over all the identifiers, or a sampling thereof. The value of D measures whether clusters are formed for each identifier and numerically represents the density of the clustering. The second metric, R, measures the robustness of the clustering of the data set. The third metric, S, measures the tightness of the clustering. Each of these metrics is an example of a measure of a clustering attribute. A desirable trait of a typical clustering result is large distances between clusters and small diameters of clusters. The silhouette scores measures this. Mathematically, the silhouette score is defined below.
a. Define a(i) as the minimum distance between point i and all other points in its cluster. This measures how dissimilar point i is with all other points in its cluster. The smaller this value is the better because it shows that i belongs in the same cluster as the other points of its cluster.
b. Define dC(i):=average {distance(i,j)|jεcluster C}. dC(i) measures how dissimilar point i is with cluster C.
c. b(i) is defined as min({dC(i)|C is a cluster from the clustering algorithm}). b(i) measures how dissimilar i is with the cluster it is most similar to. The larger this value is the better since it shows that i should not be belong in the same cluster as any of the points of other clusters.
d. Define the silhouette score of point i as s(i):=(b(i)−a(i))/max {b(i),a(i)}
e. Finally, the silhouette score for an identifier is then defined as the average (or other measure of central tendency) of s(i). This measures how tightly grouped the coordinate pairs for an identifier. This value, in many use cases, ranges between −1 and 1.

In some cases, because the number of location coordinate pairs in location histories is relatively large, some embodiments may sample a portion of the location histories for this analysis, or some embodiments may parallelize operations, e.g., with a MapReduce implementation in which clustering is mapped to a plurality of computing nodes (e.g., on a location-history by location-history basis), and counts of clusters and the other above-described values S and R are reduced out from another plurality of computing nodes. In some cases, to sufficiently evaluate quality, the location histories span relatively long durations, such as more than 24 hours, so that patterns such as work and home clusters can emerge and indicate authenticity. Embodiments, however, are also consistent with location histories spanning shorter durations, e.g., some embodiments may omit the clustering analysis, which is not to suggest that other features may not also be omitted in some cases.

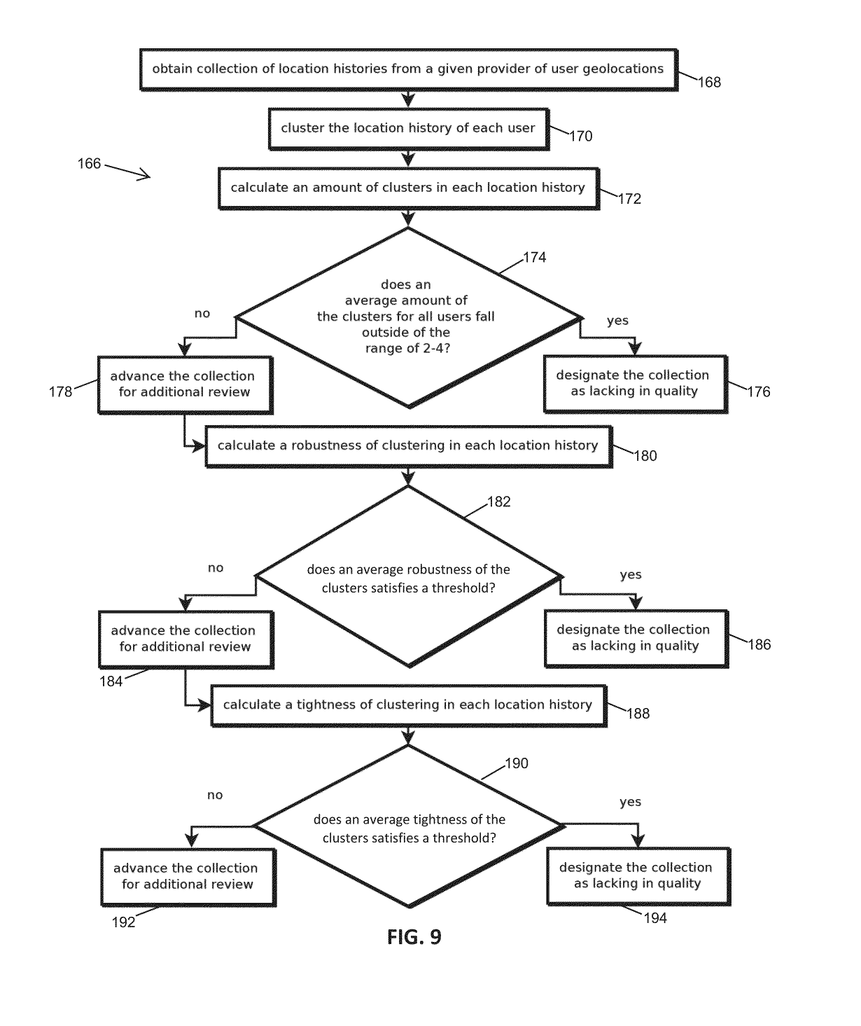

In some cases, the cluster analyzer 34 may perform the process of FIG. 9 166, steps of which are explained above by way of example. In some cases, the process includes the following steps: obtain collection of location histories from a given provider of user geolocations 168; cluster the location history of each user 170; calculate an amount of clusters in each location history 172; determining whether an average amount of the clusters for all users fall outside of the range of 2-4 174; upon such a determination, designate the collection as lacking in quality 176, otherwise, advance the collection for additional review 178; calculate a robustness of clustering in each location history 180; determine whether an average robustness of the clusters satisfies a threshold 182; upon such a determination, advance the collection for additional review 184, otherwise, designate the collection as lacking in quality 186; calculate a tightness of clustering in each location history 188; determine whether an average tightness of the clusters satisfies a threshold 190; upon such a determination, advance the collection for additional review 192, otherwise, designate the collection as lacking in quality 194.

The results of the modules 28, 30, 32, and 34, may be stored in memory in association with the respective data provider (or geolocation data set, for providers that provide multiple geolocation data sets) and may be referred to as quality attributes. In some cases, the quality attributes are calculated concurrently, or in other cases, to conserve computing resources, the attributes are calculated in a pipeline in which the process is stopped if any quality attribute fails to satisfy an intermediate threshold. The quality attributes may be advanced to the quality scoring module 35, which may determine two quality scores, the Clusterablity Score and the Hyperlocality Score.

The Clusterablity Score CS is defined and calculated by the quality scoring module 35 as follows: CS:=D*R*(1+S)/(R+(1+S)/2). That is, it is, in this example, the product of the density of the clustering and the harmonic mean of the robustness and the normalized silhouette score.

Further, the N level Hyperlocality score is defined and calculated by the quality scoring module 35 as follows: HLS_N:=(1+HEG_N)*0.5*NASF.

The results calculated by the quality scoring module 35 may be stored in the geographic-data repository 15, e.g., in association with given seller of geographically-specified ad inventory (or other geographic-data data provider 20), with a particular time period or data set from such a provider, or both. An example of resulting data is shown in the table (table 1) below, with each row including the various quality attributes for a given provider of geolocation data (e.g., a publisher or network of publishers) and the resulting quality scores. In some cases, CS and HS may each be compared to respective thresholds to determine whether the corresponding geographic data set is of adequate quality. For instance, some embodiments may designate a geographic data set as failing in response to an HS value of 0.2 or lower, and some embodiments may designate a geographic data set as failing in response to a CS value of 0.3 or lower.

| | | | | | | | | Cluster- | Hyper- |
|---|---|---|---|---|---|---|---|---|---|
| Network | Robust | Clusters | Tightness | Efficiency | Tr Bits | Norm | KLD | ability | locality |
| NW1 | 0.83 | 0.93 | 0.75 | −0.13 | 5.00 | 1.00 | 0.25 | 0.73 | 0.44 |
| NW2 | 0.73 | 0.61 | 0.59 | −0.53 | 6.51 | 1.00 | 0.11 | 0.40 | 0.24 |
| NW3 | 0.85 | 0.57 | 0.66 | −0.62 | 4.94 | 0.99 | 0.32 | 0.42 | 0.19 |
| NW4 | 0.89 | 0.79 | 0.84 | 0.56 | 4.79 | 0.96 | 0.03 | 0.68 | 0.75 |
| NW5 | 0.50 | 0.69 | 0.34 | −0.51 | 10.50 | 1.00 | 0.09 | 0.28 | 0.25 |
| NW6 | 0.79 | 0.35 | 0.51 | 0.12 | 6.24 | 1.00 | 0.29 | 0.21 | 0.56 |

In some embodiments, the CS and HS values, or resulting quality determinations may be used to calculate bid amounts for ad inventory. Some embodiments may receive an ad request associated with a particular provider of geolocation data (e.g., an ad network), retrieve from memory a measure of geolocation quality (e.g., CS, HS, or resulting quality determinations) for that provider, and calculate an amount to bid to supply an ad for the request based on the retrieved data. Some embodiments may calculate a bid amount based on a geolocation and the stored indicia of quality. For instance, some embodiments may, upon receiving the ad request, which may include a geolocation where the ad will be presented, query a geographic information system, like those discussed above, to determine a geographic-resolution sensitivity of the bid amount and calculate a bid based on each of the sensitivity, the geolocation in the ad request, and the stored indicia of quality. A geographic-resolution sensitivity may be a function of (e.g., a normalized average difference) differences in attribute scores between neighboring tiles, like those described above, and the tile of a geolocation in an ad request. In relatively geographically homogenous areas, resolution of geolocations is often less important, and some embodiments may down-weight the significance of the indicia of quality in a bid to serve an ad in response to the ad being directed to a more homogenous area. In some embodiments, a bid is calculated, sent to the ad network, and a response is received indicating that the bid was accepted. In response, an ad may be sent to the user device that initiated the ad request for presentation to the user.

Thus, some embodiments provide a sophisticated, state-of-the-art analytics pipeline (or other, e.g., concurrent processing configuration) for evaluating the quality and resolution of the time-stamped location history data that is keyed by a unique identifier. Other embodiments employ subsets of the above-described features for similar benefice ends. One example of such a data set is a collection of ad request logs containing a latitude-longitude pair, a device ID and a time-stamp. These calculated quality attributes, or metrics, are expected to capture the hyper-local quality of a set of location history data as well as how well these histories represent the typical patterns of human movement habits. In some cases, geolocation data from a given user device, a given category of user devices (e.g., model of phones), a given publisher, a category of publishers (e.g., publishers relating to sports topics), a network of publishers, or category of networks of publishers may be evaluated by calculating the above-described values. Further, in some cases, the above-described values may be calculated on an ongoing basis, for instance, weekly, daily, or hourly, to detect declines in the quality of geolocation data, for instance when a network decreases quality after securing a contract to sell advertisements, in which case, the visual inspection step described above may be omitted for subsequent calculations, which is not to suggest that other features cannot also be omitted in some embodiments.

While the preceding is described with reference to the ad industry, it should also be noted that applications are not limited to the selection of advertisements. Various other entities may use geographic data for other purposes, for example, local government for determining how to provide various government services, such as routing of roads, dispatch of police, or positioning of schools. Similarly, businesses may use the geographic data for site selection of various types of businesses, such as restaurants, automotive shops, retail stores, and the like, to position such services and facilities near people having the appropriate attributes.

FIG. 10 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstandin4rg use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

Aspects of the inventions will be better understood with reference to the following enumerated examples of embodiments:

1. A method of ascertaining the accuracy of geolocations in a collection of location histories, the method comprising: obtaining a collection of location histories describing user geolocations over a duration of time exceeding 24 hours, each location history including: a location-history identifier distinguishing the respective location history from other location histories among the collection of location histories, and time-stamped geolocation coordinates specifying geographic locations associated with a respective mobile computing device among a plurality of mobile computing devices each corresponding to at least one of the location histories, the collection of location histories describing geolocations of the plurality of mobile computing devices over time; analyzing, with one or more processors, the collection of location histories by, at least in part, calculating one or more quality attributes of the collection of location histories indicative of differences between the collection of location histories and other collections of location histories known to be of adequate quality; calculating one or more quality scores based on the one or more quality attributes; and storing the one or more quality scores in memory.
2. The method of embodiment 1, wherein analyzing the collection of location histories comprises: recording a result of a visual inspection of the collection of location histories overlaid on a map; quantifying an amount of difference between a uniform distribution of digits and a distribution of digits of geolocation coordinates in the collection of location histories; quantifying an amount of significant digits of geolocation coordinates in the collection of location histories; quantifying information efficiency of marginal digits of geolocation coordinates in the collection of location histories; and quantifying a distribution of geolocations of each of a plurality of location histories among the collection of location histories.
3. The method of embodiment 2, wherein calculating one or more quality scores based on the one or more quality attributes comprises: calculating an indicia of quality for the collection of location histories based on the quantified values.
4. The method of any of the preceding enumerated embodiments, wherein analyzing the collection of location histories comprises recording a result of a visual inspection of the collection of location histories overlaid on a map by performing steps comprising: generating a map depicting at least some of the geolocation coordinates in at least a plurality of location histories among the collection of location histories; displaying the map to a human reviewer; receiving input from the human reviewer indicative of the quality of the collection; determining that the input does not satisfy a threshold visual-inspection score; and designating the collection of location histories as lacking in quality.
5. The method of any of the preceding enumerated embodiments, wherein analyzing the collection of location histories comprises quantifying an amount of difference between a uniform distribution of digits and a distribution of digits among geolocation coordinates in the collection of location histories.
6. The method of embodiment 5, wherein the distribution of digits among geolocation coordinates corresponds to a histogram indicative of an amount of times each digit between 0 and 9, inclusive of 0 and 9, appears in the geolocation coordinates at any of a plurality of positions more than a threshold number of characters after a character corresponding to a decimal point.
7. The method of embodiment 5, wherein quantifying the amount of difference between the uniform distribution of digits and the distribution of digits among geolocation coordinates comprises: extracting latitude and longitude coordinate pairs from the location histories; storing each coordinate in the extracted latitude and longitude coordinate pairs as a string; detecting a position of a character corresponding to a decimal point in each string; identifying a portion of each string that is more than a threshold number of characters after the detected position of the character corresponding to a decimal point; counting, with a separate count for each of a plurality of digits, digit occurrences in the identified portion of each string, the separate counts for each of the plurality of digits being cumulative across multiple strings for multiple geolocation coordinates and multiple location histories; determining a total amount of characters among the identified portions of the strings; and quantifying the amount of difference between the uniform distribution of digits and the distribution of digits among geolocation coordinates based on both the total amount of characters among the identified portions of the strings and the separate counts for each of the plurality of digits.
8. The method of any of the preceding enumerated embodiments, wherein analyzing the collection of location histories comprises: performing steps for calculating metrics based on a distribution of digits in the geographic coordinates.
9. The method of any of the preceding enumerated embodiments, wherein analyzing the collection of location histories comprises: comparing a two-dimensional uniform distribution of single-digit pairs (x, y), where x and y are each numbers between 0 and 9, inclusive of 0 and 9, to a distribution of single-digit pairs from at least part of each of the geolocation coordinate pairs, the single-digit pairs from at least part of each of the geolocation coordinate pairs being pairs of digits, one from each coordinate in a respective geolocation coordinate pair, and each residing at the same position in the respective coordinate in the respective geolocation coordinate pair.
10. The method of any of the preceding enumerated embodiments, wherein analyzing the collection of location histories comprises: calculating, as a quality attribute among the one or more quality attributes, a Kullback-Leibler divergence between a distribution of digits among the geolocation coordinates and a reference distribution.
11. The method of any of the preceding enumerated embodiments, wherein analyzing the collection of location histories comprises: quantifying an amount of significant digits among geolocation coordinates in the collection of location histories.
12. The method of any of the preceding enumerated embodiments, wherein analyzing the collection of location histories comprises: for each of at least a plurality of the geolocation coordinates, counting a number of significant digits in each coordinate of a respective geolocation coordinate pair; identifying one coordinate of the respective geolocation coordinate pairs as having more significant digits than the other coordinate of the respective geolocation coordinate pairs; and calculate a measure of central tendency of the amount of significant digits of the identified coordinates.
13. The method of embodiment 12, comprising: determining that the measure of central tendency of the amount of significant digits of the identified coordinates exceeds a benchmark threshold; and in response to the determination, capping the measure of central tendency of the amount of significant digits of the identified coordinates.
14. The method of any of the preceding enumerated embodiments, wherein analyzing the collection of location histories comprises: performing steps for measuring location-history quality based on a number of significant digits with which the geolocation coordinates in the collection of location histories are reported.
15. The method of any of the preceding enumerated embodiments, wherein analyzing the collection of location histories comprises:

quantifying information efficiency of marginal digits of geolocation coordinates in the collection of location histories.

16. The method of embodiment 15, wherein quantifying information efficiency of marginal digits of geolocation coordinates in the collection of location histories comprises: truncating digits more than a first threshold number of positions from a decimal point in the geolocation coordinates to form a first set of truncated geolocation coordinates; calculating an first entropy based on the first set of truncated geolocation coordinates; truncating digits more than a second threshold number of positions from a decimal point in the geolocation coordinates to form a second of truncated geolocation coordinates, wherein the first threshold number of positions is different from the second threshold number of positions; calculating a second entropy based on the second set of truncated geolocation coordinates; and calculating an information-efficiency gain based on the first entropy and the second entropy.
17. The method of any of the preceding enumerated embodiments, wherein analyzing the collection of location histories comprises: performing steps for measuring how much information is gained as a progression through a zoom stack of the geolocation coordinates adds additional digits to the geolocation coordinates.
18. The method of any of the preceding enumerated embodiments, wherein analyzing the collection of location histories comprises: quantifying a distribution of geolocations of each of a plurality of location histories among the collection of location histories by, at least in part, for each of the plurality of location histories, ascertaining an amount of geolocation clusters that appear in the respective location history.
19. The method of embodiment 18, comprising: for each geolocation cluster, determining which geolocation coordinates in the cluster have a threshold amount of other geolocations within a threshold distance and identifying those geolocation coordinates as non-border geolocations; counting an amount of non-border geolocations in each geolocation cluster; and calculating a measure of cluster robustness based on both the count of the amount of non-border geolocations and a total number of geolocation coordinates in a corresponding location history.
20. The method of embodiment 18, comprising: calculating a measure of cluster tightness based on distances between the clusters and areas or volumes occupied by the clusters.
21. The method of embodiment 18, comprising: performing steps for measuring a clustering attribute.
22. The method of any of the preceding enumerated embodiments, comprising: performing steps for distinguishing real-life human behavior and habits from artifacts from low-quality and low-accuracy means of determining or reporting geolocations.
23. The method of any of the preceding enumerated embodiments, wherein calculating one or more quality scores based on the one or more quality attributes comprises: calculating a score based on an amount of clusters in each location history and an amount of geolocation coordinates in each cluster that have more than a threshold amount of geolocation coordinates within a threshold distance to the respective geolocation coordinate.
24. The method of any of the preceding enumerated embodiments, wherein the collection of location histories comprise geolocations included in ad requests from a single ad network, and wherein the quality scores are indicative of the quality of geolocations reported by the single ad network.
25. A tangible, non-transitory, machine-readable medium storing instructions that when executed by a data processing apparatus cause the data processing apparatus to perform operations including the method of any of the preceding enumerated embodiments.
26. A system, including: one or more processors; and memory storing instructions that when executed by the processors cause the processors to effectuate the method of any of the preceding enumerated embodiments.

What is claimed is:

1. A method of ascertaining the accuracy of geolocations in a collection of location histories, the method comprising:
obtaining a collection of location histories describing user geolocations over a duration of time exceeding 24 hours,
each location history including:
a location-history identifier distinguishing the respective location history from other location histories among the collection of location histories, and
time-stamped geolocation coordinates specifying geographic locations associated with a respective mobile computing device among a plurality of mobile computing devices each corresponding to at least one of the location histories,
the collection of location histories describing geolocations of the plurality of mobile computing devices over time;
analyzing, with one or more processors, the collection of location histories by, at least in part, calculating one or more quality attributes of the collection of location histories indicative of differences between the collection of location histories and other collections of location histories known to be of adequate quality;
calculating one or more quality scores based on the one or more quality attributes; and
storing the one or more quality scores in memory.

2. The method of claim 1, wherein analyzing the collection of location histories comprises:
recording a result of a visual inspection of the collection of location histories overlaid on a map;
quantifying an amount of difference between a uniform distribution of digits and a distribution of digits of geolocation coordinates in the collection of location histories;
quantifying an amount of significant digits of geolocation coordinates in the collection of location histories;
quantifying information efficiency of marginal digits of geolocation coordinates in the collection of location histories; and
quantifying a distribution of geolocations of each of a plurality of location histories among the collection of location histories.

3. The method of claim 2, wherein calculating one or more quality scores based on the one or more quality attributes comprises:
calculating an indicia of quality for the collection of location histories based on the quantified values.

4. The method of claim 1, wherein analyzing the collection of location histories comprises recording a result of a visual inspection of the collection of location histories overlaid on a map by performing steps comprising:
generating a map depicting at least some of the geolocation coordinates in at least a plurality of location histories among the collection of location histories;
displaying the map to a human reviewer;
receiving input from the human reviewer indicative of the quality of the collection;
determining that the input does not satisfy a threshold visual-inspection score; and
designating the collection of location histories as lacking in quality.

5. The method of claim 1, wherein analyzing the collection of location histories comprises quantifying an amount of difference between a uniform distribution of digits and a distribution of digits among geolocation coordinates in the collection of location histories.

6. The method of claim 5, wherein the distribution of digits among geolocation coordinates corresponds to a histogram indicative of an amount of times each digit between 0 and 9, inclusive of 0 and 9, appears in the geolocation coordinates at any of a plurality of positions more than a threshold number of characters after a character corresponding to a decimal point.

7. The method of claim 5, wherein quantifying the amount of difference between the uniform distribution of digits and the distribution of digits among geolocation coordinates comprises:
extracting latitude and longitude coordinate pairs from the location histories;
storing each coordinate in the extracted latitude and longitude coordinate pairs as a string;
detecting a position of a character corresponding to a decimal point in each string;
identifying a portion of each string that is more than a threshold number of characters after the detected position of the character corresponding to a decimal point;
counting, with a separate count for each of a plurality of digits, digit occurrences in the identified portion of each string, the separate counts for each of the plurality of digits being cumulative across multiple strings for multiple geolocation coordinates and multiple location histories;
determining a total amount of characters among the identified portions of the strings; and
quantifying the amount of difference between the uniform distribution of digits and the distribution of digits among geolocation coordinates based on both the total amount of characters among the identified portions of the strings and the separate counts for each of the plurality of digits.

8. The method of claim 1, wherein analyzing the collection of location histories comprises: performing steps for calculating metrics based on a distribution of digits in the geographic coordinates.

9. The method of claim 1, wherein analyzing the collection of location histories comprises:
comparing a two-dimensional uniform distribution of single-digit pairs (x, y), where x and y are each numbers between 0 and 9, inclusive of 0 and 9, to a distribution of single-digit pairs from at least part of each of the geolocation coordinate pairs, the single-digit pairs from at least part of each of the geolocation coordinate pairs being pairs of digits, one from each coordinate in a respective geolocation coordinate pair, and each residing at the same position in the respective coordinate in the respective geolocation coordinate pair.

10. The method of claim 1, wherein analyzing the collection of location histories comprises:
calculating, as a quality attribute among the one or more quality attributes, a Kullback-Leibler divergence between a distribution of digits among the geolocation coordinates and a reference distribution.

11. The method of claim 1, wherein analyzing the collection of location histories comprises:
quantifying an amount of significant digits among geolocation coordinates in the collection of location histories.

12. The method of claim 1, wherein analyzing the collection of location histories comprises:
for each of at least a plurality of the geolocation coordinates, counting a number of significant digits in each coordinate of a respective geolocation coordinate pair;
identifying one coordinate of the respective geolocation coordinate pairs as having more significant digits than the other coordinate of the respective geolocation coordinate pairs; and
calculate a measure of central tendency of the amount of significant digits of the identified coordinates.

13. The method of claim 12, comprising:
determining that the measure of central tendency of the amount of significant digits of the identified coordinates exceeds a benchmark threshold; and
in response to the determination, capping the measure of central tendency of the amount of significant digits of the identified coordinates.

14. The method of claim 1, wherein analyzing the collection of location histories comprises: performing steps for measuring location-history quality based on a number of significant digits with which the geolocation coordinates in the collection of location histories are reported.

15. The method of claim 1, wherein analyzing the collection of location histories comprises:
quantifying information efficiency of marginal digits of geolocation coordinates in the collection of location histories.

16. The method of claim 15, wherein quantifying information efficiency of marginal digits of geolocation coordinates in the collection of location histories comprises:
truncating digits more than a first threshold number of positions from a decimal point in the geolocation coordinates to form a first set of truncated geolocation coordinates;
calculating an first entropy based on the first set of truncated geolocation coordinates;
truncating digits more than a second threshold number of positions from a decimal point in the geolocation coordinates to form a second of truncated geolocation coordinates, wherein the first threshold number of positions is different from the second threshold number of positions;
calculating a second entropy based on the second set of truncated geolocation coordinates; and
calculating an information-efficiency gain based on the first entropy and the second entropy.

17. The method of claim 1, wherein analyzing the collection of location histories comprises: performing steps for measuring how much information is gained as a progression through a zoom stack of the geolocation coordinates adds additional digits to the geolocation coordinates.

18. The method of claim 1, wherein analyzing the collection of location histories comprises:
quantifying a distribution of geolocations of each of a plurality of location histories among the collection of location histories by, at least in part, for each of the plurality of location histories, ascertaining an amount of geolocation clusters that appear in the respective location history.

19. The method of claim 18, comprising:
for each geolocation cluster, determining which geolocation coordinates in the cluster have a threshold amount of other geolocations within a threshold distance and identifying those geolocation coordinates as non-border geolocations;
counting an amount of non-border geolocations in each geolocation cluster; and
calculating a measure of cluster robustness based on both the count of the amount of non-border geolocations and a total number of geolocation coordinates in a corresponding location history.

20. The method of claim 18, comprising:
calculating a measure of cluster tightness based on distances between the clusters and areas or volumes occupied by the clusters.

21. The method of claim 18, comprising: performing steps for measuring a clustering attribute.

22. The method of claim 1, comprising: performing steps for distinguishing real-life human behavior and habits from artifacts from low-quality and low-accuracy means of determining or reporting geolocations.

23. The method of claim 1, wherein calculating one or more quality scores based on the one or more quality attributes comprises:
calculating a score based on an amount of clusters in each location history and an amount of geolocation coordinates in each cluster that have more than a threshold amount of geolocation coordinates within a threshold distance to the respective geolocation coordinate.

24. The method of claim 1, wherein the collection of location histories comprise geolocations included in ad requests from a single ad network, and wherein the quality scores are indicative of the quality of geolocations reported by the single ad network.

25. The method of claim 24, comprising:
after storing the one or more quality scores in memory, receiving an ad request associated with the single ad network, the ad request including a geolocation at which the ad will be presented;
calculating a bid amount based on the one or more quality scores and the geolocation at which the ad will be presented;
submitting a bid including the calculated bid amount;
receiving an indication that the bid was accepted; and
causing an advertisement to be served responsive to the ad request.

26. A system, comprising:
one or more processors; and
memory storing instructions that when executed by at least some of the one or more processors effectuate operations comprising:
obtaining a collection of location histories describing user geolocations over a duration of time exceeding 24 hours,
each location history including:
a location-history identifier distinguishing the respective location history from other location histories among the collection of location histories, and
time-stamped geolocation coordinates specifying geographic locations associated with a respective mobile computing device among a plurality of mobile computing devices each corresponding to at least one of the location histories,
the collection of location histories describing geolocations of the plurality of mobile computing devices over time;
analyzing the collection of location histories by, at least in part, calculating one or more quality attributes of the collection of location histories indicative of differences between the collection of location histories and other collections of location histories known to be of adequate quality;
calculating one or more quality scores based on the one or more quality attributes; and
storing the one or more quality scores in the memory.
